(19) United States
(12) Patent Application Publication
(10) Pub. No.: US 2018/0170765 A1
(43) Pub. Date: Jun. 21, 2018

(54) PRODUCTION OF PRECIPITATED CALCIUM CARBONATE

(71) Applicant: COATEX, Genay (FR)

(72) Inventor: Christian JACQUEMET, Lyon (FR)

(73) Assignee: COATEX, Genay (FR)

(21) Appl. No.: 15/579,772

(22) PCT Filed: Jun. 30, 2016
(86) PCT No.: PCT/FR2016/051624

§ 371 Date: Dec. 5, 2017

(30) Foreign Application Priority Data
Jul. 17, 2015 (FR) 1556789

(51) Int. Cl. C01F 11/18; C04B 2/06

(52) U.S. Cl. CPC C01F 11/181; C01P 2006/82; C04B 2/06

(57) ABSTRACT

The present invention relates to the use of a depolymerized carboxylated cellulose solution for preparing an aqueous Precipitated Calcium Carbonate (PCC) slurry by slaking a material containing calcium oxide in water, followed by carbonation of the milk of lime thus obtained. The depolymerized carboxylated cellulose solution has a solid content of 25 wt. % to 40 wt. %, based on the total weight of the solution and a molecular weight of between 10 000 g/mol to 40 000 g/mol.

The present invention relates to the use of a depolymerized carboxylated cellulose for preparing an aqueous Precipitated Calcium Carbonate (PCC) slurry, said depolymerized carboxylated cellulose optionally being used in combination with at least one slaking additive.

### BACKGROUND OF THE INVENTION

Calcium carbonate is one of the most widely used additives in the paper, paint and plastics industries. Natural Calcium Carbonate (NCC) is, for example, used as mineral filler in numerous applications. For its part, Precipitated Calcium Carbonate (PCC) can be manufactured tailor-made in terms of morphology and particle size, which confers other properties on the materials which contain it. Scalenohedral Precipitated Calcium Carbonate (S-PCC) is used in particular as mineral filler in combination with cellulose fibers in filler applications in paper.

The processes for the production of PCC comprise the steps consisting of the slaking of a material containing calcium oxide (generally known as “quicklime”) with water, so as to produce a calcium hydroxide slurry (generally known as “milk of lime”), followed by the subsequent synthesis of the calcium carbonate by circulating carbon dioxide through said resulting calcium hydroxide slurry. Such processes produce PCC slurries having a low dry solids content. Consequently, these processes generally comprise an additional concentration step in order to obtain a PCC slurry exhibiting a higher dry solids content, which is advantageous during the transportation of the PCC slurry. Nevertheless, such additional concentration steps are energy-consuming and cost-intensive and necessitate having to resort to a specific item of equipment (for example a centrifuge, requiring high maintenance). Furthermore, the use of such items of equipment can result in the destruction of the structure of the PCC formed, as is in particular the case with S-PCC prepared in the form of clusters.

Processes for the preparation of PCC in the presence of different additives are described in the literature.

A certain number of documents are concerned with the preparation of PCC in the presence of negatively charged polymers, for example (meth)acrylic acid polymers.

In particular, the document WO 2005/000742 A1 relates to a process for the preparation of lamellar PCC comprising the steps consisting in forming a calcium hydroxide slurry, carbonating said slurry, and in adding a polyacrylate to the slurry before the end of the carbonation in order to precipitate the lamellar calcium carbonate.

Also, the unpublished patent application EP 14166751.9, filed on behalf of the present applicants, relates to the use of a combination of at least one water-soluble polymer (for example a polyacrylic acid) and of at least one slaking additive in a process for the production of an aqueous precipitated calcium carbonate slurry.

Other documents describe the use of positively charged additives prepared, for example, from monomeric units having a quaternary amine.

The unpublished patent application FR 15 51690, filed on behalf of the present applicants, relates to the use of a cationic polymer, optionally in the presence of a slaking additive, in a process for the production of an aqueous precipitated calcium carbonate slurry. The invention described in this document makes it possible to prepare PCC slurries having cationic surface charges, even at alkaline pH values.

Finally, other documents are concerned with the use of at least partially biosourced additives. For example, the patent application WO 2007/067146 A1 describes a process for the preparation of PCC in the presence of starch or of carboxymethylcellulose (CMC).

The document EP 2 868 716 relates to the use of depolymerized carboxymethylcellulose for helping in the grinding of minerals for the purpose of preparing an aqueous slurry of mineral particles.

The paper by Sonobe et al. entitled Polymorphism, size and shape control of calcium carbonate crystals in the presence of a polyelectrolyte relates to the carbonation conditions according to which crystallographic modifications of the calcium carbonate can be obtained by means of polyacrylates or of neutralized CMC.

The document US 2013/0312925 relates to the improvement in the mechanical or optical properties of paper by employing different polysaccharides, including CMC, during the preparation of PCC subsequently used during the preparation of paper.

### OBJECTS OF THE INVENTION

One object of the present invention is to provide a solution for the production of PCC slurries using an additive of biosourced origin, that is to say not resulting from fossil energy. This step comes within a concept of green chemistry and of sustainable development.

Another object of the present invention is to provide a solution for the production of PCC slurries having, for example, a high dry solids content, without having recourse to an additional step of thermal or mechanical concentration.

Another object of the present invention is to provide a solution for the production of PCC slurries having a high dry solids content possessing viscosities which can be easily managed, that is to say a solution which makes it possible to increase the dry solids content of PCC slurries, while preventing an increase in the viscosity of the slurries.

It is also desirable for said solution not to negatively affect the kinetics of the carbonation step and/or not to detrimentally affect the crystallographic structure of the PCC.

Another object of the present invention is to provide a solution for the preparation of PCC slurries to be used directly as mineral filler in a process for the manufacture of paper.

### BRIEF DESCRIPTION OF THE INVENTION

The present invention relates to the use of at least one depolymerized carboxylated cellulose solution for preparing an aqueous Precipitated Calcium Carbonate (PCC) slurry by slaking of a material containing calcium oxide in water, followed by carbonation of the milk of lime thus obtained.

According to one embodiment of the present invention, said polymerized carboxylated cellulose solution exhibits a solids content of between 25 wt % and 40 wt. %, based on the total weight of the solution.

According to another embodiment, said depolymerized carboxylated cellulose exhibits a molecular weight Mw of between 10 000 g/mol and 40 000 g/mol.

The present invention relates, in addition, to the use of a combination of at least one depolymerized carboxylated cellulose solution and of at least one slaking additive in a process for the production of an aqueous precipitated calcium carbonate slurry.

The present invention also relates to the use of at least one depolymerized carboxylated cellulose solution for preparing Precipitated Calcium Carbonate (PCC) in the dry form, by slaking of a material containing calcium oxide in water, carbonation of the milk of lime thus obtained and at least drying of the PCC slurry.

### DETAILED DESCRIPTION OF THE INVENTION

### Definitions

For the purposes of the present invention, the terms cited below should be understood as having the following meanings:

“Material containing calcium oxide” is understood to mean a mineral or synthetic material having a calcium oxide content of at least 50 wt. %, for example of at least 75 wt. %, or of at least 90 wt. % or also of at least 95 wt. %, based on the total weight of the material containing calcium oxide.

“Mineral material” is understood to mean a solid substance having a defined inorganic chemical composition and a characteristic crystalline and/or amorphous structure.

“Natural Calcium Carbonate (NCC)” is understood to mean a calcium carbonate obtained from natural sources, such as limestone, marble or chalk, and subjected to a wet and/or dry treatment, such as a grinding, a sieving and/or fractionation, for example using a cyclone or a sorter.

“Precipitated Calcium Carbonate (PCC)” is understood to mean a synthetic material generally obtained by precipitation subsequent to the reaction of carbon dioxide and of calcium hydroxide (hydrated lime) in an aqueous medium or by precipitation of a source of calcium and of a source of carbonate in water. Moreover, the precipitated calcium carbonate can also be the product which makes it possible to introduce calcium and carbonate salts, calcium chloride and sodium carbonate, for example in an aqueous medium. The PCC can be in the vaterite, calcite or aragonite form. PCCs are described, for example, in the documents EP 2 447 213 A1, EP 2 524 898 A1, EP 2 371 766 A1.

For the purposes of the present invention, the “dry solids content” or “solids content” of a liquid composition is a measure of the remaining amount of material after evaporation of all the solvents or of water.

Throughout the present document, the “particle size” of the precipitated calcium carbonate or of the other particulate materials is described by its particle size distribution. The value dₓ represents the diameter for which x wt. % of the particles have a diameter of less than dₓ. This means that the value d₂₀ is the particle size at which 20 wt. % of all the particles have a diameter of less than the value d and the value d₉₈ is the particle size at which 98 wt. % of all the particles have a diameter of less than the value d. The value d₉₈ is also known as “top cut”. The value d₅₀ is known as the weight medium particle size, that is to say that 50 wt. % of the particles have a diameter of less than or greater than this particle size. For the purposes of the present invention, the particle size is indicated as being the weight medium particle size d₅₀, unless otherwise indicated. Use may be made, in order to determine the weight medium particle size d₅₀ or the particle size of the top cut d₉₈, of a Sedigraph 5100 or 5120 device from Micromeritics, USA.

A “specific surface according to the BET method (SS)”, within the meaning of the present invention, is defined as being the surface area of the precipitated calcium carbonate particles divided by the weight of the PCC particles. As used here, the specific surface is measured by N₂ adsorption using BET isotherms (ISO 9277: 1995) and is indicated in m²/g.

Within the meaning of the present invention, “stable in an aqueous slurry having a pH of 12 and a temperature of 90° C.” means that the polymeric additive retains its physical properties and its chemical structure when it is added to an aqueous slurry having a pH of 12 and a temperature of 90° C. For example, the polymeric additive retains its dispersing qualities and is not depolymerized or degraded under said conditions.

For the purposes of the present invention, the term “viscosity” or “Brookfield viscosity” refers to the Brookfield viscosity. The Brookfield viscosity is measured using a Brookfield viscometer (RVT type) at 25° C.±1° C. at 100 rev/min using an appropriate spindle and is indicated in mPa·s.

For the purposes of the present invention, “water-soluble” materials are defined as being materials which, when they are mixed with deionized water and filtered through a filter having a pore size of 0.2 μm at 20° C. in order to recover the liquid filtrate, result in a weight of less than or equal to 0.1 g of solid material recovered after evaporation of 100 g of said liquid filtrate between 95° C. and 100° C. “Water-soluble” materials are defined as being materials resulting in a weight of greater than 0.1 g of solid material recovered after evaporation of 100 g of said liquid filtrate between 95° C. and 100° C.

A “slurry”, within the meaning of the present invention, comprises insoluble solids and water, and optionally other additives. It is capable of containing large amounts of solids and thus of being more viscous and of having a greater density than that of the liquid from which it is formed.

The term “comprising”, as used in the present description and the present claims, does not exclude other elements. For the purposes of the present invention, the term “consisting of” is regarded as being a preferred embodiment of the term “comprising”. If a group is defined hereinafter as comprising at least a certain number of embodiments, it should also be understood that it describes a group which preferably consists only of these embodiments.

The terms “which can be obtained” or “which can be defined” and “obtained” or “defined” are used interchangeably. For example, this means that, unless the context stipulates otherwise, the term “obtained” does not indicate that an embodiment has to be obtained by the sequence of steps following the term “obtained”, even if such a limited understanding is always included by the term “obtained” or “defined” as a preferred embodiment.

### Depolymerized Carboxylated Cellulose and Process of the Preparation

“Carboxylated cellulose” is understood to mean a cellulose which has been chemically modified and comprises carboxyl units, for example carboxymethyl —CH₂—COOH units. The carboxylated cellulose is, at least partially, of biosourced origin. It can be supplied in the powder form or in the solution form, for example in the aqueous solution form.

According to one embodiment of the present invention, the carboxylated cellulose is carboxymethylcellulose.

In the context of the present invention, use is made of a carboxylated cellulose which has been depolymerized in order to exhibit a molecular weight optimal for the present application. This is because the inventors demonstrate that the use of a non-depolymerized CMC does not make it possible to increase the dry solids content of the milk of lime while maintaining a viscosity which allows the slurry to be handled.

In the context of the present invention, the terms “polymeric additive” and “depolymerized carboxylated cellulose” are used equivalently.

According to one embodiment of the present invention, said depolymerized carboxylated cellulose solution is obtained according to a process described in the patent application WO 2015/063402. In particular, said depolymerized carboxylated cellulose solution can be obtained according to a process comprising:
1) a depolymerization step, according to which:
   1a) a carboxylated cellulose to be depolymerized exhibiting a degree of substitution of between 0.2 and 2 is available,
   1b) a reactor containing water is heated to a temperature of between 50° C. and 85° C. (limits included), for example to a temperature of between 75° C. and 85° C. (limits included),
   1c) the carboxylated cellulose to be depolymerized and a peroxide are gradually and simultaneously added to a reactor while maintaining the temperature according to 1b), and
   1d) after addition of all of the reactants according to 1c), the temperature of the mixture is maintained according to 1b) until the peroxide has been completely consumed,
2) a step of cooling the mixture to a temperature of less than 75° C., for example to a temperature of less than 70° C., and
3) optionally a step of neutralization of the mixture.

According to one embodiment of the present invention, the depolymerized carboxylated cellulose exhibits a molecular weight Mw of between 10 000 g/mol and 40 000 g/mol, for example between 13 000 g/mol and 35 000 g/mol or, for example, between 13 000 g/mol and 25 000 g/mol.

The molecular weight of the depolymerized carboxylated cellulose can be determined by Size Exclusion Chromatography (SEC) or Gel Permeation Chromatography (GPC). This method is described in particular in the patent application WO 2015/063402. In addition, a precise measurement example is given in the experimental part of the present patent application.

The polydispersity index PI corresponds to the distribution of the molecular weights of the different macromolecules within the cellulose obtained. If all the macromolecules exhibit a similar molecular weight Mw, the PI index decreases and approaches the theoretical value of 1. If, on the other hand, the macromolecules exhibit different molecular weights, the PI index increases.

According to one embodiment of the present invention, said depolymerized carboxylated cellulose exhibits a polydispersity index PI of between 2 and 10, for example of between 3 and 5.

According to one embodiment, the depolymerized carboxylated cellulose is provided in the form of a solution.

According to one embodiment of the present invention, the depolymerized carboxylated cellulose solution exhibits a solids content of greater than 25 wt. %, for example of between 25 wt. % and 40 wt. %, based on the total weight of the solution; or a solids content of greater than 30 wt. %, for example between 30 wt. % and 40 wt. %, based on the total weight of the solution, or for example between 31 wt. % and 35 wt. %.

According to one embodiment of the present invention, said depolymerized carboxylated cellulose is partially or completely neutralized by means of one or more neutralizing agent(s) chosen from the group consisting of sodium hydroxides, calcium hydroxides, magnesium hydroxides, potassium hydroxides and amines.

### Material Containing Calcium Oxide

The aqueous PCC slurry is prepared by slaking of a material containing calcium oxide CaO. Thus, in the process for the production of an aqueous precipitated calcium carbonate slurry, a material containing calcium oxide is provided. Said material containing calcium oxide can be obtained by calcining a material containing calcium carbonate. Calcination is a heat treatment process applied to the material containing calcium carbonate in order to bring about a thermal decomposition resulting in the formation of calcium oxide and carbon dioxide gas. The materials containing calcium carbonate which can be used in such a calcination process are those chosen from the group comprising precipitated calcium carbonates, natural minerals containing calcium carbonate, such as marble, limestone and chalk, and minerals containing a mixture of alkaline earth metal carbonates comprising calcium carbonate, such as dolomite or fractions rich in calcium carbonate originating from other sources. It is also possible to subject a waste material containing calcium carbonate to a calcination process in order to obtain a material containing calcium oxide.

Calcium carbonate decomposes at approximately 1000° C. to give calcium oxide (commonly known as quicklime). The calcination step can be carried out under conditions and using items of equipment well known to a person skilled in the art. As a general rule, the calcination can be carried out in furnaces or reactors (sometimes known as kilns) of various designs, in particular shaft furnaces, rotary kilns, multiple hearth furnaces and fluidized bed reactors.

The end of the calcination reaction can be determined, for example, by monitoring the change in density, the residual content of carbonate, for example by X-ray diffraction, or the reactivity of the slaking by standard methods.

According to one embodiment of the present invention, the material containing calcium oxide is obtained by calcining a material containing calcium carbonate, for example chosen from the group consisting of precipitated calcium carbonate, natural minerals containing calcium carbonate, such as marble, limestone and chalk, minerals containing a mixture of alkaline earth metal carbonates comprising calcium carbonate, such as dolomite, or their mixtures.

For reasons of effectiveness, it is preferable for the material containing calcium oxide to have a minimum content of calcium oxide of at least 75 wt. %, preferably at least 90 wt. % and particularly preferably 95 wt. %, based on the total weight of the material containing calcium oxide. According to one embodiment, the material containing calcium oxide consists of calcium oxide.

The material containing calcium oxide can consist of just one type of material containing calcium oxide. Alternatively, the material containing calcium oxide can consist of a mixture of at least two types of materials containing calcium oxide.

The material containing calcium oxide can be used in the process of the invention in its original form, that is to say in the raw material form, for example in the form of more or less large chunks. Alternatively, the material containing calcium oxide can be ground before use. According to one embodiment of the present invention, the material containing calcium carbonate is in the form of particles having a weight medium particle size d₅₀ ranging from 0.1 μm to 1000 μm and, for example, from 1 μm to 500 μm.

### Use of the Depolymerized Carboxylated Cellulose

The present invention relates to the use of a depolymerized carboxylated cellulose for preparing a Precipitated Calcium Carbonate (PCC).

More specifically, the present invention relates to the use of a depolymerized carboxylated cellulose solution for preparing a Precipitated Calcium Carbonate (PCC) in the dry form or in the form of an aqueous solution or aqueous slurry.

The processes for the production of an aqueous PCC slurry generally comprise the steps consisting in (i) preparing a milk of lime by mixing water and the material containing calcium oxide, and optionally the at least one slaking additive, and (ii) carbonating the milk of lime obtained in step (i) in order to form an aqueous precipitated calcium carbonate slurry.

“Carbonating” is understood to mean circulating carbon dioxide within the calcium hydroxide Ca(OH)₂ slurry, so as to form precipitated calcium carbonate CaCO₃.

According to the present invention, at least one depolymerized carboxylated cellulose solution is used for preparing an aqueous Precipitated Calcium Carbonate (PCC) slurry by slaking of a material containing calcium oxide in water, followed by carbonation of the milk of lime thus obtained, said depolymerized carboxylated cellulose solution exhibiting a solids content of between 25 wt. % and 40 wt. %, based on the total weight of the solution, and a molecular weight Mw of between 10 000 g/mol and 40 000 g/mol.

### Slaking Step

In the first step of the process for the production of PCC, that is to say “the slaking step” (called step i) above), a milk of lime is prepared by mixing water, the material containing calcium oxide, the depolymerized carboxylated cellulose and optionally the at least one slaking additive.

The reaction of the material containing calcium oxide with water results in the formation of a milky calcium hydroxide slurry, better known under the name of milk of lime. Said reaction is highly exothermic and is also known in the art as “lime slaking”.

According to one embodiment, said depolymerized carboxylated cellulose solution is present in the slaking water of the material containing calcium oxide.

According to one embodiment of the present invention, the temperature of the water, which is used in the slaking step, that is to say the temperature of the water which is used for the slaking of the material containing calcium oxide, is adjusted in order to be within the range extending from 0° C. to 100° C., for example from 1° C. to 70° C. or from 2° C. to 50° C. or from 30° C. to 50° C. or from 35° C. to 45° C. It will appear obvious to a person skilled in the art that the initial temperature of the water is not necessarily the same as the temperature of the mixture prepared in the slaking step as a result of the highly exothermic nature of the slaking reaction and/or of the mixing of substances having different temperatures.

According to one embodiment of the present invention, the slaking step of the process comprises the steps consisting in:
a1) mixing the depolymerized carboxylated cellulose solution with water and optionally the at least one slaking additive, and
a2) adding the material containing calcium oxide to the mixture of step a1).

According to one embodiment, step a1) is carried out at a temperature of between 0° C. and 99° C., for example between 1° C. and 70° C. or between 2° C. and 50° C. or between 30° C. and 50° C. or between 35° C. and 45° C.

According to another embodiment of the present invention, the slaking step of the process comprises the steps consisting in:
b1) mixing the material containing calcium oxide, the depolymerized carboxylated cellulose solution and optionally the at least one slaking additive, and
b2) adding water to the mixture of step b1).

According to yet another embodiment of the present invention, in the slaking step of the process, the material containing calcium oxide, the depolymerized carboxylated cellulose, optionally the at least one slaking additive and water are mixed simultaneously. According to yet another embodiment of the present invention, the at least one slaking additive is added before or after the slaking step of the process.

The depolymerized carboxylated cellulose solution can be added in the slaking step in its entirety or in several parts, for example in two, three, four, five or more parts.

The slaking step of the process can be carried out at ambient temperature, that is to say at a temperature of 20° C.±2° C., or at an initial temperature of between 30° C. and 50° C. or between 35° C. and 45° C. As the reaction is exothermic, the temperature generally reaches a temperature of between 85° C. and 99° C. during step i), preferably a temperature of between 90° C. and 95° C. According to a preferred embodiment, step i) of the process is carried out by mixing or by stirring, for example with mechanical stirring. The appropriate item of equipment for the mixing or the stirring of the process is known to a person skilled in the art.

The progression of the slaking reaction can be observed by measuring the temperature and/or the conductivity of the reaction mixture.

The inventors have found, with surprise, that the addition of a specific depolymerized carboxylated cellulose as defined above and optionally of a slaking additive as defined above, before or during the slaking step of a process for the production of PCC, can make possible the preparation not only of a milk of lime having a low dry solids content but also of a milk of lime having a high dry solids content. This is because it is advantageous to note that, according to one aspect of the invention, by carbonating said highly concentrated milk of lime, it is possible to obtain an aqueous PCC slurry which also has a high dry solids content. Consequently, the process of the present invention does not require an additional concentration step in order to obtain a PCC slurry having a high dry solids content.

According to one embodiment of the present invention, the milk of lime of the slaking step has a dry solids content of at least 15 wt. %, for example ranging from 15 wt. % to 45 wt. % or for example from 20 wt. % to 40 wt. % or for example from 25 wt. % to 37 wt. %, based on the total weight of the milk of lime.

According to one embodiment of the present invention, the milk of lime of the slaking step has a Brookfield viscosity ranging from 1 mPa·s to 1000 mPa·s at 25° C., for example from 5 mPa·s to 800 mPa·s at 25° C. or for example from 10 mPa·s to 500 mPa·s at 25° C., as measured at 100 rev/min.

In the context of the present invention, additional water can be introduced during the slaking reaction in order to control and/or maintain and/or reach the desired dry solids content or the desired Brookfield viscosity of the milk of lime.

The slaking step of the process can be carried out in the form of a batchwise, semibatchwise or continuous process.

In the slaking step, the material containing calcium oxide and the water can be mixed in a weight ratio ranging from 1:1 to 1:12, for example from 1:2 to 1:12, for example from 1:2.5 to 1:6.

According to one embodiment, said depolymerized carboxylated cellulose solution is used in combination with at least one slaking additive.

In this case, the at least one slaking additive can be chosen from the group consisting of organic acids, organic acid salts, sugar alcohols, monosaccharides, disaccharides, polysaccharides, gluconates, phosphonates, lignosulfonates and their mixtures.

According to one embodiment, the at least one slaking additive is chosen from the group consisting of sodium citrate, potassium citrate, calcium citrate, magnesium citrate, monosaccharides, disaccharides, polysaccharides, sucrose, sugar alcohols, meritol, citric acid, sorbitol, the sodium salt of diethylenetriaminepentaacetic acid, gluconates, phosphonates, sodium tartrate, sodium lignosulfonate, calcium lignosulfonate and their mixtures.

### Carbonation Step

In this step of the process for the production of PCC, that is to say the carbonation step (called step ii) above), the milk of lime obtained on conclusion of the slaking step is carbonated in order to form an aqueous precipitated calcium carbonate slurry.

The carbonation is carried out by means and under conditions well known to a person skilled in the art. The introduction of carbon dioxide into the milk of lime rapidly increases the concentration of carbonate (CO₃²⁻) ions and calcium carbonate is formed. In particular, the carbonation reaction can be easily controlled by taking into account the reactions involved in the carbonation process. The carbon dioxide dissolves, according to its partial pressure, to form carbonate ions via the formation of carbonic acid (H₂CO₃) and of hydrogencarbonate (HCO₃⁻) ions which are unstable in alkaline solution. During the continuous dissolution of the carbon dioxide, the hydroxide ions are consumed and the concentration of carbonate ions increases until the concentration of dissolved calcium carbonate is greater than the solubility product and the solid calcium carbonate precipitates.

According to one embodiment of the present invention, the carbonation is carried out by incorporating pure carbon dioxide gas or industrial gases containing at least 10 vol. % of carbon dioxide in the milk of lime.

The progression of the carbonation reaction can be easily observed by measuring the conductivity and/or the pH. In this regard, the pH of the milk of lime before the addition of carbon dioxide will be greater than 10, generally of between 11 and 12.5, and will continually decrease until a pH of approximately 7 is obtained. The reaction can then be halted.

The conductivity slowly decreases during the carbonation reaction and then rapidly decreases to reach low values when the precipitation is complete. The progression of the carbonation can be monitored by measuring the pH and/or the conductivity of the reaction mixture.

According to one embodiment of the process for the production of PCC, the temperature of the milk of lime obtained on conclusion of the slaking step, which is used in the carbonation step, is adjusted in order to be within the range extending from 20° C. to 60° C. and for example from 30° C. to 50° C. It will be clearly apparent to a person skilled in the art that the initial temperature of the milk of lime is not necessarily the same as the temperature of the mixture prepared in the carbonation step as a result of the exothermic nature of the carbonation reaction and/or of the mixing of substances having different temperatures.

According to one embodiment of the process for the production of PCC, the carbonation step is carried out at a temperature of between 5° C. and 95° C., for example from 30° C. to 70° C. and for example from 40° C. to 60° C.

The carbonation step of the process can be carried out in the form of a batchwise, semibatchwise or continuous process. According to one embodiment, the process for the production of PCC involving the slaking and carbonation steps of the process is carried out in the form of a batchwise, semibatchwise or continuous process.

According to one embodiment of the present invention, the process for the production of PCC does not comprise a step of concentrating the aqueous precipitated calcium carbonate slurry obtained in the slaking and carbonation steps of the process.

Thus, the present invention relates to the use of depolymerized carboxylated cellulose in a process for the preparation of PCC, more specifically in the step of preparation of a milk of lime which has to be subsequently carbonated.

Without wishing to be committed to any one theory, it may be thought that the affinity of the PCC particles formed during the process described above with the cellulose fibers or fibrils of the paper sheet is improved as a result of the use of said depolymerized carboxylated cellulose during the process for the production of PCC. This is because, when the depolymerized carboxylated cellulose is present during the step of slaking of the material containing calcium oxide in order to form the PCC, it may be thought that the depolymerized carboxylated cellulose is incorporated within the PCC particles and thus plays a binding role between these PCC particles and the fibrous mat of the cellulose used to form the paper sheet.

According to one embodiment of the present invention, the use of depolymerized carboxylated cellulose during the process for the preparation of PCC confers, on the aqueous PCC slurries produced, a zeta potential of less than 0 mV but greater than the zeta potential of a PCC prepared in the presence of negatively charged polymers, for example (meth)acrylic acid polymers, in particular those described in the application WO 2005/000742 A1, which remains an advantage for the filler application.

According to another embodiment, the aqueous PCC slurries obtained using the depolymerized carboxylated cellulose are characterized in that they have a zeta potential of less than 0 mV, for example of between 0 mV and −40 mV, for example between 0 mV and −30 mV.

According to one embodiment, the use of depolymerized carboxylated cellulose during the process for the preparation of the PCC confers, on the aqueous PCC slurries produced, a Mütek charge of less than 0 μeq/g.

According to another embodiment, the aqueous PCC slurries obtained by using the depolymerized carboxylated cellulose are characterized in that they exhibit a Mütek charge of less than 0 μeq/g, for example of between 0 μeq/g and −1 μeq/g or between 0 μeq/g and −0.8 μeq/g.

According to one embodiment of the present invention, the depolymerized carboxylated cellulose is added during the first step of the process for the production of PCC, that is to say that the depolymerized carboxylated cellulose is added before or during the slaking step. The milk of lime, known to a person skilled in the art, obtained by slaking of a material containing calcium oxide with water generally has a pH of between 11 and 12.5, measured at a temperature of 25° C., according to the concentration of the material containing calcium oxide in the milk of lime. Given that the slaking reaction is exothermic, the temperature of the milk of lime can reach a temperature of greater than 80° C., for example of between 80° C. and 99° C. According to one embodiment, the depolymerized carboxylated cellulose, used in the context of the present invention, is chosen so as to be stable in an aqueous slurry having a pH of 12 and a temperature of 90° C. Within the meaning of the present invention, “stable in an aqueous slurry having a pH of 12 and a temperature of 90° C.” means that the polymeric additive retains its physical properties and its chemical structure when it is added to an aqueous slurry having a pH of 12 and a temperature of 90° C. For example, the polymeric additive retains its dispersing qualities and has not degraded under said conditions.

According to one embodiment of the present invention, the depolymerized carboxylated cellulose is added in an amount ranging from 0.01 wt. % to 2 wt. %, for example from 0.02 wt. % to 1 wt. % and for example from 0.05 wt. % to 0.5 wt. %, based on the total weight of the material containing calcium oxide.

### Slaking Additive

In the first step of the process for the production of PCC (or slaking step), at least one slaking additive can be used in addition to the depolymerized carboxylated cellulose.

Thus, according to one embodiment, said depolymerized carboxylated cellulose solution is used in combination with at least one slaking additive.

The at least one slaking additive can be chosen from the group consisting of organic acids, organic acid salts, sugar alcohols, monosaccharides, disaccharides, polysaccharides, gluconates, phosphonates, lignosulfonates and their mixtures.

According to one embodiment of the present invention, the at least one slaking additive is chosen from the group consisting of sodium citrate, potassium citrate, calcium citrate, magnesium citrate, monosaccharides, disaccharides, polysaccharides, sucrose, sugar alcohols, meritol, citric acid, sorbitol, the sodium salt of diethylenetriaminepentaacetic acid, gluconates, phosphonates, sodium tartrate, sodium lignosulfonate, calcium lignosulfonate and their mixtures. According to a preferred embodiment, the at least one slaking additive is sodium citrate and/or sucrose.

According to one embodiment of the present invention, the at least one slaking additive used consists of just one type of slaking additive. Alternatively, the at least one slaking additive used can consist of a mixture of at least two types of slaking additives.

The at least one slaking additive can be added in an amount ranging from 0.01 wt. % to 2 wt. %, based on the total amount of material containing calcium oxide, for example in an amount ranging from 0.05 wt. % to 1 wt. %, for example from 0.06 wt. % to 0.8 wt. % or for example from 0.07 wt. % to 0.5 wt. %.

The addition of a slaking additive can be of use in controlling the size of the PCC particles and their crystalline morphology without affecting the viscosity of the aqueous slurry.

As was mentioned above, the inventors have found, with surprise, that the addition of a depolymerized carboxylated cellulose as defined above, optionally in combination with the addition of a slaking additive before or during the slaking step of a process for the production of PCCs, can make possible the preparation of a PCC slurry having a high dry solids content. It is also believed that the omission of a concentration step improves the quality of the PCC particles produced, given that the surface damage of the particles, which may occur during the concentration step, is avoided. It is also estimated that said PCC slurry can be further concentrated up to a solids content of 52 wt. % with acceptable viscosities, for example Brookfield viscosities of less than or equal to 1000 mPa·s at 25° C. and at 100 rev/min.

### Additional Steps of the Process

The process for the production of precipitated calcium carbonate can comprise additional steps.

The milk of lime can be sieved in order to remove oversized particles. An appropriate sieve can comprise, for example, a sieve having a sieve size of 100 μm to 700 μm, for example approximately 100 μm or approximately 300 μm. According to one embodiment of the present invention, the milk of lime is sieved after the slaking step and before the carbonation step, for example using a sieve having a sieve size ranging from 100 μm to 300 μm.

The process for the production of precipitated calcium carbonate can further comprise an additional step of separation of the precipitated calcium carbonate from the aqueous slurry obtained on conclusion of the carbonation step.

For the purposes of the present invention, the expression “separation” or “separating” means that the PCC is removed or isolated from the aqueous slurry obtained in the carbonation step of the process. Any conventional separating means known to a person skilled in the art can be used, for example a mechanical and/or thermal means. Examples of mechanical separation processes are filtration, for example by means of a drum filter or of a filter press, nanofiltration or centrifugation. An example of a thermal separation process is a process for concentrating by application of heat, for example in an evaporator.

The PCC obtained can be transformed, for example deagglomerated or subjected to a dry grinding step. It can also be wet ground in the form of a slurry. If the PCC is subjected to dewatering, dispersing and/or grinding steps, these steps can be accomplished by methods known in the art. Wet grinding can be carried out in the absence or in the presence of a grinding aid agent. Dispersants can also be included in order to prepare dispersions, if appropriate.

The process for the production of precipitated calcium carbonate can further comprise an additional step of drying the precipitated calcium carbonate, for example separated precipitated calcium carbonate obtained on conclusion of the separating step described above.

The term “drying” refers to a process according to which at least a portion of the water is removed from a material which has to be dried, so that a constant weight of the “dry” material obtained at 120° C. is achieved. Furthermore, a “dry” material can in addition be defined by its total moisture content which, unless otherwise indicated, is less than or equal to 1.0 wt. %, preferably less than or equal to 0.5 wt. %, more preferably less than or equal to 0.2 wt. % and particularly preferably of between 0.03 wt. % and 0.07 wt. %, based on the total weight of the dry material.

In general, the drying step can be carried out using any appropriate item of drying equipment and can, for example, comprise thermal drying and/or drying under reduced pressure, using an item of equipment such as an evaporator, a flash dryer, an oven or a spray dryer, and/or drying in a vacuum chamber.

The drying step results in a dry precipitated calcium carbonate having a low total moisture content which is less than or equal to 1.0 wt. %, based on the total weight of the dry precipitated calcium carbonate.

The precipitated calcium carbonate obtained by the process of the invention can be post-treated, for example during and/or after a drying step, with an additional component. According to one embodiment, the precipitated calcium carbonate is treated with a fatty acid, for example stearic acid, a silane or fatty acid phosphoric esters.

According to one embodiment of the process for the production of PCC, the precipitated calcium carbonate obtained has a weight medium particle size d₅₀ ranging from 0.1 μm to 100 μm, for example from 0.25 μm to 50 μm, for example from 0.3 μm to 5 μm and for example from 0.4 μm to 3.0 μm.

The precipitated calcium carbonate can have an aragonite, calcite or vaterite crystalline structure or mixtures of these structures. Another advantage of the present invention is that the crystalline structure and the morphology of the precipitated calcium carbonate can be controlled, for example by adding seed crystals or other structure-modifying chemical products. According to a preferred embodiment, the precipitated calcium carbonate obtained by the process of the invention has a clustered scalenohedral crystalline structure.

The BET specific surface of the precipitated calcium carbonate obtained by the process according to the present invention can range from 1 m²/g to 100 m²/g, for example from 2 m²/g to 70 m²/g, for example from 3 m²/g to 50 m²/g, for example from 4 m²/g to 30 m²/g, measured using nitrogen and the BET method in accordance with the ISO 9277 standard. The BET specific surface of the precipitated calcium carbonate obtained by the process of the present invention can be controlled by using additives, for example surface-active agents, which involve shearing during the precipitation step or subsequently at high mechanical shear rates, which results not only in a small particle size but also in a high BET specific surface.

According to one embodiment of the present invention, the precipitated calcium carbonate slurry obtained has a dry solids content of at least 10 wt. %, for example ranging from 20 wt. % to 50 wt. %, for example from 25 wt. % to 45 wt. % or for example from 30 wt. % to 40 wt. %, based on the total weight of the slurry.

According to one embodiment of the present invention, the PCC slurry has a Brookfield viscosity of less than or equal to 1000 mPa·s at 25° C., for example of less than or equal to 800 mPa·s at 25° C. or for example of less than or equal to 600 mPa·s at 25° C., as measured at 100 rev/min.

Another aspect of the present invention relates to the use of a combination of at least one water-soluble polymer and of a slaking additive in a process for the production of an aqueous precipitated calcium carbonate slurry, in which:
the depolymerized carboxylated cellulose solution exhibits a solids content of between 25 wt. % and 40 wt. %, based on the total weight of the solution, and a molecular weight of between 10 000 g/mol and 40 000 g/mol, and
the slaking additive is chosen from the group consisting of organic acids, organic acid salts, sugar alcohols, monosaccharides, disaccharides, polysaccharides, gluconates, phosphonates, lignosulfonates and their mixtures.

### EXAMPLES

### 1. Measurement Methods

The measurement methods employed in the examples are described below.

### Brookfield Viscosity

The Brookfield viscosity of the aqueous slurries was measured after one hour of production and after one minute of stirring at 25° C.±1° C. at 100 rev/min using a Brookfield viscometer of RVT type equipped with an appropriate disc spindle, for example a 2 to 5 spindle.

### pH Measurement

The pH of a slurry or of a solution was measured at 25° C. using a Mettler Toledo Seven Easy pH meter and a Mettler Toledo InLab® Expert Pro pH electrode. A three-point calibration (according to the segmentation method) of the instrument was carried out first using commercially available (from Sigma-Aldrich Corp., USA) buffer solutions having a pH of 4, 7 and 10 at 20° C. The pH values given are the final values detected by the instrument (the measurement is terminated when the signal measured differs by less than 0.1 mV from the mean over the last 6 seconds).

### Particle Size Distribution

The particle size distribution of the PCC particles prepared was measured using a Sedigraph 5100 device from Micromeritics, USA. The method and the instrument are known to a person skilled in the art and are commonly used to determine the grain size of mineral fillers and pigments. The measurement was carried out in an aqueous solution comprising 0.1 wt. % of Na₄P₂O₇. The samples were dispersed using a high-speed stirrer and ultrasound. No other dispersing agent was added for the measurement of the dispersed samples.

### Dry Solids Content of an Aqueous Slurry

The dry solids content of the slurry (also known as “dry weight”) was determined using an MJ33 Moisture Analyzer from Mettler-Toledo, Switzerland, with the following settings: drying temperature of 160° C., automatic halting if the weight does not vary by more than 1 mg over a period of 30 seconds, standard drying of 5 g to 20 g of slurry.

### Specific Surface (SS)

The specific surface was measured using the BET method in accordance with the ISO 9277 standard using nitrogen, followed by conditioning of the sample by heating at 250° C. for a period of 30 minutes. Before carrying out these measurements, the sample is filtered on a Büchner funnel, rinsed with deionized water and dried overnight in an oven at a temperature of between 90° C. and 100° C. Subsequently, the dry filtration cake is meticulously ground in a mortar and the resulting powder is placed in a moisture analysis balance at 130° C. until a constant weight is obtained.

### Specific Carbonation Time

The monitoring of the conductivity, which slowly decreases during the carbonation reaction and then rapidly decreases to reach a minimum value, therefore indicating that the reaction is complete, was used to determine the time necessary to make possible complete precipitation. The specific carbonation time (min/kg of Ca(OH)₂) was determined by the following formula:

$$Specific carbonation time = \frac{{10}^{5} \cdot Tf}{W \cdot {DSC}_{MoL}}$$

in which:
Tf (min) is the time necessary to complete the carbonation of the milk of lime, as determined by monitoring the conductivity,
W (g) is the weight of the milk of lime introduced into the carbonation reactor, and
DSC_{MoL} (%) is the dry solids content by weight of the milk of lime.

### Measurement of the Charge—Mütek

The measurement of the charge is carried out using a Mütek PCD 03 device equipped with a Mütek PCD titrator.

From 0.5 g to 1 g of dry PCC is weighed in the plastic measuring cell and diluted with 20 ml of deionized water. The displacement piston is put in the “on” position. While the piston oscillates in the cell, there is a wait for the flow current between the two electrodes to stabilize.

The sign of the measured value displayed on the screen indicates whether the charge of the sample is positive (cationic) or negative (anionic). A polyelectrolyte of opposite charge having a known charge density is added to the sample as titrating agent (either 0.001N sodium polyoxyethylene sulfate or 0.001N pDADMAC). The charges of the titrating agent neutralize the existing charges of the sample. The titration is interrupted as soon as the point of zero charge (0 mV) is reached.

The consumption of the titrating agent in mL is used as basis for the subsequent calculations. The amount of specific charge q [eq/g of slurry] is calculated according to the following formula:

a=(V*c)/w

V: volume of titrating agent consumed [l]
c: concentration of the titrating agent [eq/l] or [μeq/l]
w: weight of the weighed slurry [g]
a: amount of specific charge [eq/g of slurry] or [μeq/g of slurry]

### Zeta Potential

In order to measure the zeta potential, a few drops of PCC slurry are dispersed in a sufficient amount of serum obtained by mechanical filtration of said slurry in order to obtain a slightly cloudy colloidal suspension.

This suspension is introduced into the measuring cell of the Zetasizer Nano-ZS device from Malvern which directly displays the value of the zeta potential of the PCC slurry in mV.

### 2. Preparation of a Depolymerized CMC

The process for the preparation of the depolymerized CMC according to the invention comprises three steps: a depolymerization step, a cooling step and a neutralization step.

### Depolymerization Step

800 g of bi-permuted water and 0.017 g of FeSO₄.7H₂O catalyst are introduced into a one-liter reactor. The reactor is heated to 80° C.±2° C. There is then injected, for 2 h 45, a 35 wt. % hydrogen peroxide solution at 189 mg/min and also CMC (Sigma-Aldrich with the reference 419281, Mw=250 000 g/mol, DS=1.2) in aliquots of 25 g every 15 minutes (continuous process). The reaction is allowed to continue for 2 h 30 after the end of the injections. It is confirmed that all of the hydrogen peroxide has been consumed.

### Cooling Step

The reactor is cooled to 70° C. The pH as measured in the reactor is 4.4.

### Neutralization Step

A 10% NaOH solution is introduced so as to achieve a pH of 7.4.

### Characterization of the Depolymerized CMC Thus Obtained:

| V_{B} at t₀ (mPa · s) | =water |
|---|---|
| V_{B} of the depolymerized CMC solution obtained (mPa · s) | 725 |
| SC (wt. %) | 33.9 |
| Total duration of process | 4 h 45 |
| Mw (g/mol) | 13 310 |
| PI | 4 |

### Method for Determination of the Molecular Weight (Mw) and PI Index of the Depolymerized CMC:

The molecular weight of the CMC is determined by Size Exclusion Chromatography (SEC) or Gel Permeation Chromatography (GPC).

Such a technique employs in the case in point a liquid chromatography device of the Waters™ brand having a detector. This detector is a refractometric concentration detector of the Waters™ brand.

This liquid chromatography appliance has a size exclusion column suitably chosen by a person skilled in the art in order to separate the different molecular weights of the CMCs studied. The liquid elution phase is an aqueous phase adjusted to pH 9.00 with 1N sodium hydroxide containing 0.05M of NaHCO₃, 0.1M of NaNO₃, 0.02M of triethanolamine and 0.03% of NaN₃.

In a detailed manner, according to a first step, the CMC solution is diluted to a solids content of 0.9% in the dissolution solvent of the SEC, which corresponds to the liquid elution phase of the SEC, to which 0.04% of dimethylformamide, which acts as a flow marker or an internal standard, is added. Filtration is then carried out through a 0.2 μm filter. 100 μl are subsequently injected into the chromatography device (eluent: an aqueous phase adjusted to pH 9.00 with 1N sodium hydroxide containing 0.05M of NaHCO₃, 0.1M of NaNO₃, 0.02M of triethanolamine and 0.03% of NaN₃).

The liquid chromatography device contains an isocratic pump (Waters™ 515), the flow rate of which is adjusted to 0.8 ml/min. The chromatography device also comprises an oven which itself comprises, in series, the following system of columns: a precolumn of Waters™ Guard Column Ultrahydrogel type with a length of 6 cm and an internal diameter of 40 mm and a linear column of Waters™ Ultrahydrogel type with a length of 30 cm and an internal diameter of 7.8 mm. For its part, the detection system is composed of a refractometric detector of Waters™ 410 RI type. The oven is brought to a temperature of 60° C. and the refractometer is brought to a temperature of 45° C.

The chromatography device is calibrated with sodium polyacrylate powder standards with different molecular weights certified for the supplier: Polymer Standards Service or American Polymer Standards Corporation.

### 3. Preparation of Precipitated Calcium Carbonate (PCC):

A milk of lime was prepared by mixing, with mechanical stirring, water and different polymer additives, optionally in the presence of a slaking additive (for example dry sodium citrate, NaCi), at an initial temperature of between 40° C. and 41° C. (the amounts of polymer additives and optionally of slaking additives are shown in table 1 below). Subsequently, calcium oxide (quicklime raw material from Golling, Austria) was added with stirring. The mixture obtained was stirred for 25 min and then sieved through a 200 μm sieve.

The milk of lime obtained was transferred into a stainless steel reactor, in which the milk of lime was cooled to 50° C. The milk of lime was then carbonated by introducing an air/CO₂ mixture (26 vol. % of CO₂ and a flow rate of 23 l/min). During the carbonation step, the reaction mixture was stirred at a speed of 1400 rev/min. The kinetics of the reaction was monitored by inline pH and conductivity measurements.

### Exemplified Polymer Additives:

P1=depolymerized CMC prepared according to 2 (according to the invention),
P2=non-depolymerized CMC—Blanose® Ashland 12M8P (degree of substitution 1.2 and molecular weight 395 000 g/mol) (outside the invention), and
P3=sodium polyacrylate (outside the invention)—Mw=4270 g/mol, PI=2.3 (Mw and PI determined according to the unpublished patent application EP 14166751.9).

TABLE 1
Characteristics of the milks of lime

| | | | | | | Solids |
|---|---|---|---|---|---|---|
| | | | | | | content |
| | | | Amount | | Amount of | of the |
| | | | of polymer | | slaking | milk of |
| | | Polymer | additive | Slaking | additive | lime |
| | | additive | [wt. % CaO] | additive | [wt. % CaO] | [wt. %] |
| 1 | OINV | none | — | NaCi | 0.1 | 25.2 |
| 2 | OINV | none | — | NaCi | 0.1 | 16.2 |
| 3 | INV | P1 | 0.15 | NaCi | 0.1 | 28.1 |
| 4 | OINV | P2 | 0.15 | NaCi | 0.1 | 28.1 |
| 5 | OINV | P3 | 0.15 | NaCi | 0.1 | 29.5 |

(INV: according to the INVention - OINV: Outside the INVention)

The characteristics of the milks of lime and of the aqueous PCC slurries prepared are described in table 2 below.

TABLE 2
Characteristics of the milks of lime and of the aqueous PCC slurries

| | Viscosity of | | Solids | Viscosity | | | | |
|---|---|---|---|---|---|---|---|---|
| | the milk of | Carbonation | content of | of S-PCC | Zeta | | | |
| | lime (mPa · s) | time (min/kg of | S-PCC | (mPa · s) | potential | Mütek | D₅₀ | SS |
| Test | at 100 rev/min | Ca(OH)₂) | [wt. %] | at 100 rev/min | (mV) | (μeq/g) | (μm) | (m²/g) |
| 1 OINV | Viscosity of the milk of lime excessively high | | | | Not measured | | | |
| 2 OINV | 23 | 44.2 | 20.5 | 20 | +5.5 | 0.1 | 1.6 | 4.7 |
| 3 INV | 410 | 47 | 36.6 | 597 | −29.1 | −0.5 | 1.5 | 4.7 |
| 4 OINV | Viscosity of the milk of lime excessively high - effect | | | | Not measured | | | |
| 5 OINV | 329 | 46.5 | 37.6 | 940 | −35.2 | −0.9 | 1.3 | 5 |

(INV: according to the INVention - OINV: Outside the INVention)

The results recorded in table 2 show that the use of a slaking additive alone results in a milk of lime having a high Brookfield viscosity (test 1) and that it is not possible to increase the dry solids content of the milk of lime (wt. %) while preventing the increase in the viscosity of the slurry (comparison of test 1 and of test 2).

On the other hand, sample 3 according to the invention confirms that the viscosities of the milk of lime and of the PCC slurry which are obtained are compatible with the anticipated use of the PCC thus obtained, that is to say PCC slurries having a Brookfield viscosity of less than or equal to 1500 mPa·s at 25° C., for example of less than or equal to 1000 mPa·s at 25° C. or of less than or equal to 600 mPa·s at 25° C., at 100 rev/min.

Furthermore, the kinetics of carbonation and the crystallographic structure of the PCC prepared (results not provided) are similar to those obtained with a process involving the use of an anionic polymer (polymer P3 outside the invention, solely by way of comparison).

1. A method for preparing an aqueous Precipitated Calcium Carbonate slurry, the method comprising
slaking a material containing calcium oxide in water by using at least one depolymerized carboxylated cellulose solution to obtain a milk of lime, and
subsequently carbonating the milk of lime,
wherein the depolymerized carboxylated cellulose solution has a solid content of 25 wt. % to 40 wt. %, based on a total weight of the solution and a molecular weight Mw of 10 000 g/mol to 40 000 g/mol.

2. The method of claim 1, wherein the depolymerized carboxylated cellulose has a polydispersity index PI of 2 to 10.

3. The method of claim 1, wherein the depolymerized carboxylated cellulose is partially or completely neutralized by one or more neutralizing agents selected from the group consisting of a sodium hydroxide, a calcium hydroxide, a magnesium hydroxide, a potassium hydroxide, and an amine.

4. The method of claim 1, wherein the depolymerized carboxylated cellulose solution is present in the slaking water of the material containing calcium oxide.

5. The method of claim 1, wherein the material containing calcium oxide and the water are mixed in a weight ratio ranging from 1:1 to 1:12.

6. The method of claim 1, wherein the depolymerized carboxylated cellulose solution is used in combination with at least one slaking additive.

7. The method of claim 6, wherein the at least one slaking additive is selected from the group consisting of sodium citrate, potassium citrate, calcium citrate, magnesium citrate, a monosaccharide, a disaccharide, a polysaccharide, sucrose, a sugar alcohol, meritol, citric acid, sorbitol, a sodium salt of diethylenetriaminepentaacetic acid, a gluconate, a phosphonate, sodium tartrate, sodium lignosulfonate, and calcium lignosulfonate.

8. The method of claim 1, wherein the milk of lime has a Brookfield viscosity ranging from 1 mPa·s to 1000 mPa·s at 25° C., at 100 rev/min.

9. The method of claim 1, wherein the precipitated calcium carbonate slurry has a Brookfield viscosity of less than or equal to 1000 mPa·s at 25° C., at 100 rev/min.

10. The method of claim 1, wherein the precipitated calcium carbonate slurry has a dry solid content of at least 10 wt. %, based on a total weight of the slurry.
